(19) United States
(12) Patent Application Publication
(10) Pub. No.: US 2015/0340947 A1
(43) Pub. Date: Nov. 26, 2015

(54) BOOST-BUCK BASED POWER CONVERTER

(71) Applicant: Infineon Technologies Austria AG, Villach (AT)

(72) Inventors: Gerald Deboy, Klagenfurt (AT); Albert Frank, Klagenfurt (AT)

(21) Appl. No.: 14/286,410

(22) Filed: May 23, 2014

(51) Int. Cl. H02M 3/155; H02J 3/38

(52) U.S. Cl. CPC H02M 3/155; H02J 3/385

(57) ABSTRACT

A power converter circuit may include a plurality of power converters, each comprising an input configured to receive input power from a power source, an output, a first converter connected to the input, and a second converter connected between the first converter and the output. The outputs of the plurality of power converters may be connected in series at an output of the power converter circuit. The first converter may include a first inductor and the second converter may include a second inductor.

### TECHNICAL FIELD

This disclosure in general relates to a power converter, in particular a power converter configured to convert power received from a photovoltaic (PV) panel.

### BACKGROUND

With an increasing interest in sustainable energy production there is a focus on using photovoltaic arrays for producing electric power. Photovoltaic (PV) panels include at least one photovoltaic (PV) cell, that is also known as solar cell. Since the output voltage of one cell is relatively low, a PV panel usually includes a string with a plurality of series connected solar cells and may include several such strings connected in parallel.

In order to efficiently operate a PV panel a maximum power point (MPP) tracker (MPP) can be connected to the PV panel. The MPP operates the PV panel substantially in the maximum power point and supplies an output power based on an input power received from the PV panel. Several such MPP trackers each having a PV panel connected thereto can be connected in series in order to supply an output voltage that is higher than output voltage of only one MPP tracker. It is generally desirable to have low losses in operating the PV panels in the MPP and in the conversion of the power provided by the individual PV panels into an output power provided by the MPP tracker series circuit.

### SUMMARY

One embodiment relates to a power converter circuit. The power converter circuit includes a plurality of power converters each including an input configured to receive input power from a power source, an output, a first converter connected to the input, and a second converter connected between the first converter and the output. The outputs of the plurality of power converters are connected in series at an output of the power converter circuit. Further, the first converter includes a first inductor, and the second converter includes a second inductor.

Another embodiment relates to a method. The method includes receiving an input power from a power source by each of a plurality of power converters. Each power converter includes an input configured to receive the input power, an output, a first converter connected to the input, and a second converter connected between the first converter and the output. The outputs of the plurality of power converters are connected in series at an output of the power converter circuit. The converter includes a first inductor, and the second converter includes a second inductor.

### BRIEF DESCRIPTION OF THE DRAWINGS

Examples are explained below with reference to the drawings. The drawings serve to illustrate certain principles, so that only aspects necessary for understanding these principles are illustrated. The drawings are not to scale. In the drawings the same reference characters denote like features.

FIG. 1 schematically illustrates the equivalent circuit diagram of a photovoltaic (PV) panel;

FIG. 2A illustrates the output current and the output power of a PV panel over the output voltage at different solar powers;

FIG. 2B illustrates the position of a maximum power point (MPP) on the characteristic curves shown in FIG. 2A;

FIG. 3 shows one embodiment of a power converter circuit which each power converter including a first converter and a second converter;

FIG. 4 shows one embodiment of one power converter;

FIG. 5 shows one embodiment of a first converter in greater detail;

FIG. 6 shows timing diagrams that illustrate one operation mode of the first converter shown in FIG. 5;

FIG. 7 shows timing diagrams that illustrate another operation mode of the first converter shown in FIG. 5;

FIG. 8 shows one embodiment of a second converter in greater detail;

FIG. 9 shows timing diagrams that illustrate one operation mode of the second converter shown in FIG. 8;

FIG. 10 shows timing diagrams that illustrate another operation mode of the second converter shown in FIG. 7;

FIG. 11A illustrates one embodiment of how one power converter may be operated;

FIG. 11B illustrates another embodiment of how one power converter may be operated;

FIG. 12 illustrates another embodiment of the power converter circuit; and

FIG. 13 illustrates yet another embodiment of the power converter circuit.

### DETAILED DESCRIPTION

In the following detailed description, reference is made to the accompanying drawings. The drawings form a part of the description and by way of illustration show specific embodiments in which the invention may be practiced. It is to be understood that the features of the various embodiments described herein may be combined with each other, unless specifically noted otherwise.

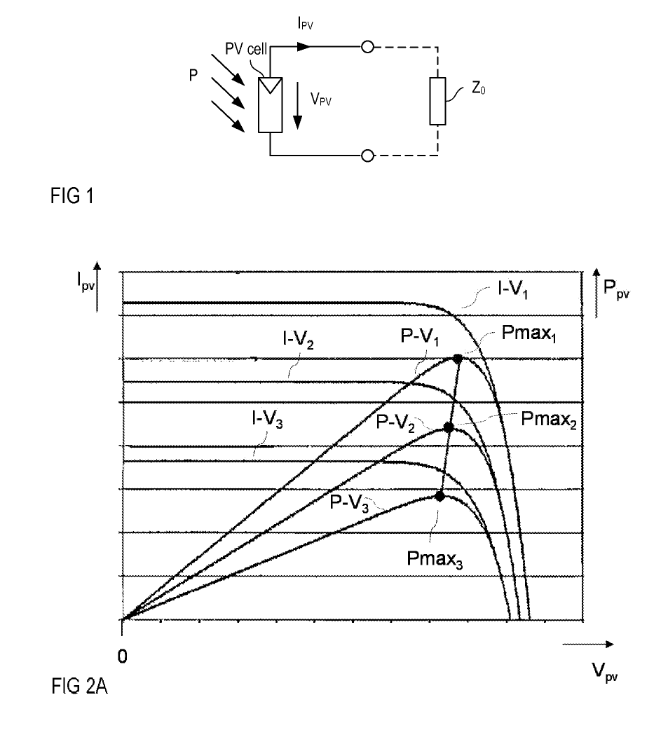

For a better understanding of the embodiments explained below FIG. 1 schematically illustrates a photovoltaic (PV) panel. The PV panel may include one solar cell (PV cell), a string with a plurality of solar cells connected in series, or even several such strings connected in parallel. The PV panel when exposed to solar irradiation provides an electric output power P_{PV}. The output power P_{PV} is represented by an output voltage V_{PV} and an output current I_{PV}. The output current will also be referred to as photo current in the following. The output power P_{PV} corresponds to the product of the output voltage V_{PV} and the output current I_{PV} and can be used to supply an electric load Z₀ (illustrated in dashed lines).

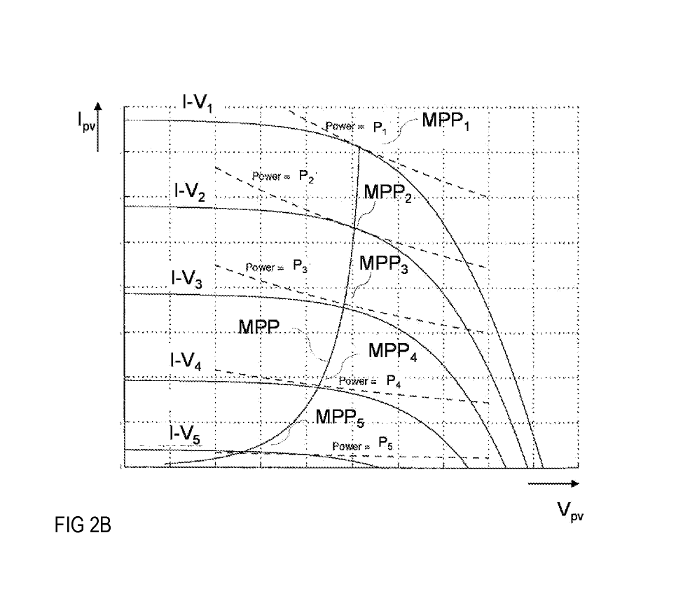

FIG. 2A schematically illustrates several characteristic curves of a photovoltaic cell obtained at different irradiation powers. One characteristic curve illustrates the photo current I_{PV} dependent on the photo voltage V_{PV}. In FIG. 2A three different characteristic curves I-V₁, I-V₂, I-V₃ are illustrated. At a given output voltage V_{PV} the photo current I_{PV} increases as the irradiation power increases. As can be seen from the characteristic curves illustrated in FIG. 2A the photo current I_{PV} is approximately constant for voltages lower than a threshold voltage, and rapidly decreases at voltages higher than the threshold voltage. Silicon based solar cells have a threshold voltage of about 0.6V.

FIG. 2A further illustrates the output power Pₚᵥ of the solar cell dependent on the output voltage V_{PV} at different irradiation powers. The output power P_{PV} increases as the irradiation power increase. In FIG. 2A curves P-V₁, P-V₂, P-V₃ illustrate the output power at three different irradiation powers. Each of these curves has a maximum Pmax₁, Pmax₂, Pmax₃, respectively.

What makes the operation of PV panels and, thus, the operation of photovoltaic arrays with a plurality of PV panels difficult, is the fact that at different irradiation powers the maximum output power is obtained at different output voltages Vₚᵥ and different output currents Iₚᵥ. To illustrate this, FIG. 2B illustrates a number of characteristic curves I-V₁ to I-V₅ obtained at different irradiation powers, and the points on each of these characteristic curves at which the maximum output power is obtained. These points, that are referred to as maximum power points (MPP), are defined by a unique pair including an output current and a corresponding output voltage. In the characteristic curves I-V₁ to I-V₅ shown in FIG. 2B the maximum power points are denoted as MPP₁ to MPP₅. Curve MPP in FIG. 2B illustrates the maximum power points at different irradiation powers. It can be seen that, at the maximum power points, the photo current Iₚᵥ and the output voltage Vₚᵥ increases as the irradiation power increases. Summarizing the above, each irradiation power received by the PV panel has a unique output current Iₚᵥ and a corresponding output voltage Vₚᵥ of the PV panel at which the output power Pₚᵥ of the PV panel has a maximum.

In order to maximize the electric power provided by a PV panel a maximum power point tracker (MPPT) can be used. An MPPT is configured to adjust an output current I_{PV} and a output voltage V_{PV} received from the PV panel such that the PV panel operates in the MPP or close to the MPP. This is explained in further detail herein below.

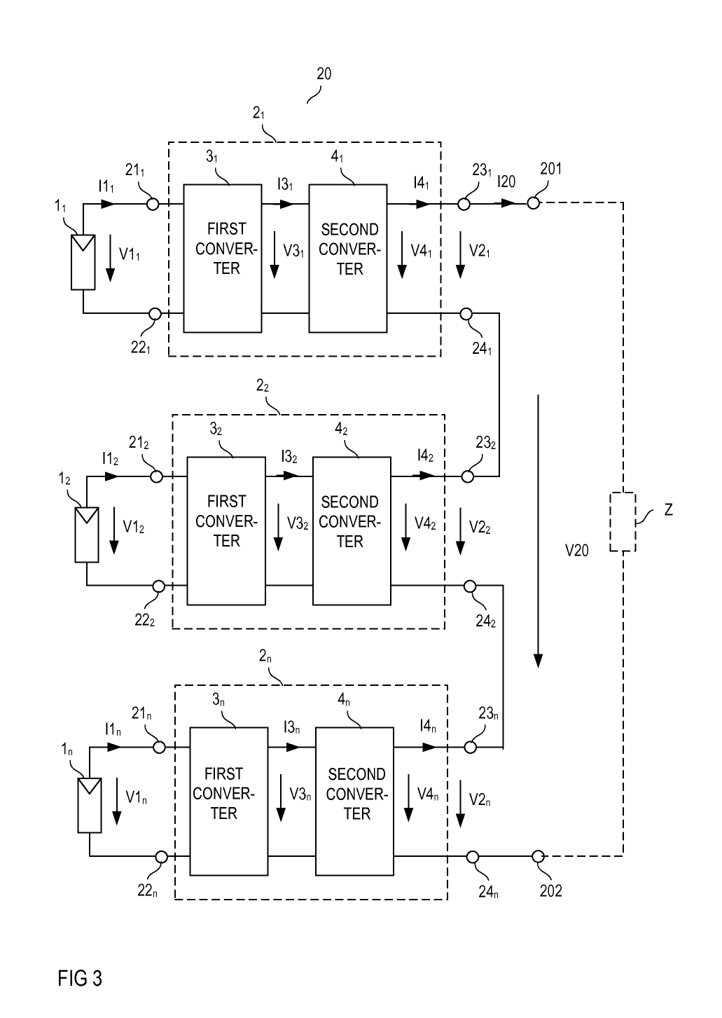

FIG. 3 shows one embodiment of a power converter circuit 20 which is configured to receive input power from a plurality of power sources 1₁, 1₂, 1 ₙ, and to provide an output power at an output 201, 202 from these input powers received from the power sources I₁-Iₙ. According to one embodiment, each of the power sources 1₁-1ₙ includes a photovoltaic (PV) panel. Each of these PV panels includes at least one solar cell (PV cell). According to one embodiment, each PV panel includes a string with several solar cells connected in series, and may include several such strings connected in parallel. Each of the input powers the power converter circuit 20 received from the individual power sources 1₁-1ₙ is represented by an input current I1₁, I1₂, I1ₙ and a corresponding input voltage V1₁, V1₂, V1ₙ. The input power provided by each power source 1₁-1ₙ is given by the input current 1₁-1ₙ multiplied with the corresponding input voltage V1₁-V1ₙ.

The output power provided by the power converter circuit 20 is represented by an output current I20 and an output voltage V20, wherein the output power is given by the output current I20 multiplied with the output voltage V20. A load Z (illustrated in dashed lines in FIG. 3) connected to the output with a first out-put node 201 and a second output node 202 may receive the output power from the power converter circuit 20. One embodiment of the load Z is explained with reference to FIG. 9 herein below. According to one embodiment, the load Z defines the output current I20. That is, the load Z acts like a current sink which defines the current I20 drawn from the power converter circuit. In this case, the output voltage V20 of the power converter circuit 20 may vary dependent on the power supplied to the power converter circuit 20 by the individual power sources 1₁-1ₙ.

Referring to FIG. 3, the power converter circuit 20 includes a plurality of power converters 2₂, 2ₙ. In FIG. 3, like features of the individual power converters 2₁-2ₙ have same reference characters which are only different by having different subscript indices. For example, the individual features of a first power converter 2₁ have reference characters with a subscript index “1”, the individual features of a second power converter 2₁ have reference characters with a subscript index “2”, and so on. In the following, when statements apply to each of the power converters 2₂-2ₙ or when a differentiation between the individual power converters 2₁-2ₙ is not necessary, the individual power converters 2₁-2ₙ are described using reference characters without index. Equivalently, the individual power sources 1₁-1ₙ and their features (the input current and the input voltage) have the same reference characters that are only different by having different subscript indices. Like with the power converters 2₁, 2ₙ, the power sources 1₁-1ₙ are described using reference characters without index if statements apply to each of the power sources 1₁-1ₙ or if a differentiation between the individual power sources 1₁-1ₙ is not necessary.

Referring to FIG. 3, each of the power converters 2 includes an input with a first input node 21 and a second input node 22, and an output with a first output node 23 and a second output node 24. The input 21, 22 of each power converter 2 is connected to one power source 1 so that each power converter 2 receives the input power from one power source 1. The outputs 23, 24 of the individual power converters 2 are connected in series (cascaded). So that the output voltage V20 of the power converter 20 equals a sum of the output voltages V2₁, V2₂, V2ₙ of the individual power converters 2₁-2ₙ.

The power converter circuit 20 shown in FIG. 3 includes n=3 power sources and a corresponding number of n=3 power converters 2₁-2ₙ. However, this is only an example. The number of power sources 1 and power converters 2 in one power converter circuit 20 is arbitrary. That is, the power converter circuit 20 could be implemented with two or more than three power sources 1 and power converters 2 as well.

Referring to FIG. 3, each of the power converters 2 includes a first converter 3 connected to the corresponding power source 1, and a second converter 4 connected between the first converter 3 and the output 23, 24 of each power converter 2. According to one embodiment, the first converter 3 is a boost converter, and the second converter 4 is a buck converter. The first converter 3 receives the input power from the corresponding power source 1 and provides an output power represented by an output current I3 and an output voltage V3 of the first converter 3, and the second converter 4 receives the output power from the first converter 3 and provides the output power of the power converter 2. That is, an output power of the second converter 4, which is represented by an output current I4 and an output voltage V4, corresponds to the output power of the power converter 2.

The second converters 4₁-4ₙ of the individual power converters 2₁-2ₙ are configured to generate the corresponding output current I4₁-I4ₙ such that these output currents I4₁-I4ₙ are substantially identical and correspond to the output current I20 of the power converter circuit 20. The output voltages V2₁-V2ₙ of the individual power converters 2 (which correspond to the output voltages V4₁-V4ₙ of the second converters 4₁-4ₙ) can be different from each other and may vary dependent on a varying input power received from the individual power sources 1₁-1 ₙ. This is explained in greater detail herein below.

According to one embodiment, each of the individual power converters 2 operates as a maximum power point tracker (MPPT) which is configured to operate the corresponding PV panel 1 substantially in the maximum power point (MPP). That is, each of the power converters 2 is configured to adjust at least one of the input current I1 and the corresponding input voltage V1 received from the corresponding power source 1 such that the power source 1 operates substantially in the MPP. As the power one power converter 3 receives from the corresponding power source 1 may vary dependent on a solar power received by the power source 1, the output power of the power converter 2 (as represented by the output current I20 and the output voltage V2) may vary.

According to one embodiment, in one power converter 2 only one of the first and second converters 2, 3 is activated at one time in order to operate the PV panel in the MPP, while the other one of the first and second 2, 3 is deactivated. In this case, the activated one of the first and second power converters 2, 3 adjusts at least one of the current I1 and the voltage V1 received from the power source 1, while the deactivated one of the first and second power converters 2, 3 simply allows the current I1 to pass through. This is explained in further detail herein below.

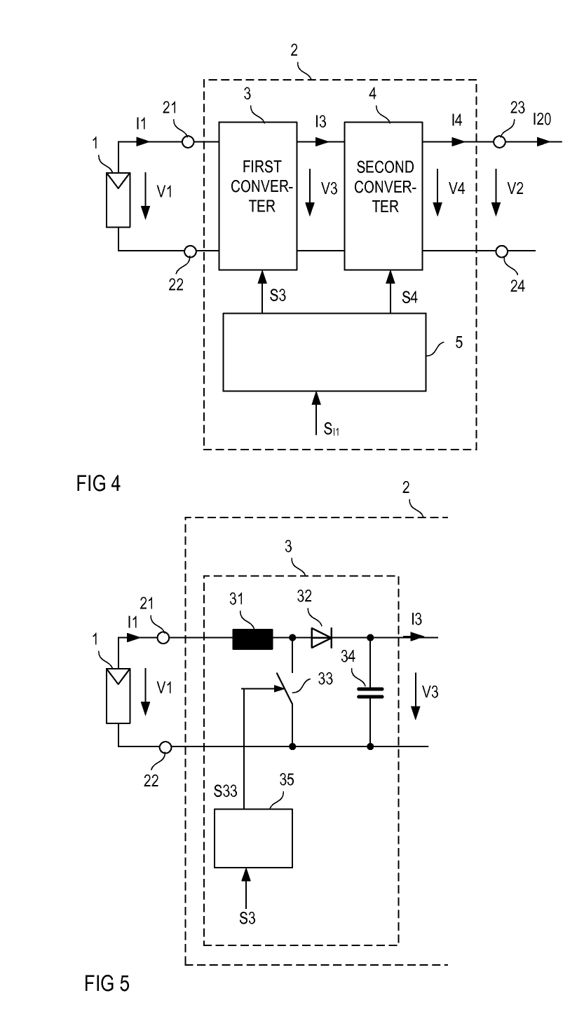

FIG. 4 illustrates one embodiment of one power converter 2. Besides the first converter 3 and the second converter 4 this power converter 2 includes a controller which controls operation of the first and second converter 3, 4. In particular, the controller 5 activates one of the first and second converters 3, 4 and deactivates the other one of the first and second converters 3, 4 at one time. Referring to FIG. 4, the first converter 3 may receive a first control signal S3 from the controller 5, and the second converter 4 may receive a second control signal S4 from the controller 5. Each of the first and second control signals S3, S4 defines the operation mode of the corresponding first or second converter 3, 4. That is, the first control signal S3 defines the operation mode of the first converter 3, and the second control signal S3 defines the operation mode of the second converter 4. The “operation mode” of each of the first and second converters 3, 4 includes whether the respective converter 3, 4 is activated or deactivated, and, in the activated state, the level of the input current I1 the respective converter 3, 4 receives (draws) from the power source 1. That is, the operation state of each of the first and second converters 3, 4 is defined by the activation state (which can be activated or deactivated), and, in the activated state, the level of the input current I1 drawn by the respective converter 3, 4.

According to one embodiment, the controller 5 is configured to generate the first and second control signals S3, S4 based on an input current signal S_{I1} that represents the input current I1, an input voltage signal S_{V1} that represents the input voltage V1, and an output voltage signal S_{V2} that represents the output voltage V2 of the power converter 2. According to one embodiment, “to represent” means that the signal (S_{V1}, S_{I1}, S_{V2}) received by the controller 5 is proportional to the corresponding parameter (V1, I1, V2) it represents.

According to one embodiment, the controller 5, by suitably controlling the first converter 3 and the second converter 4, is configured to operate the power source (PV panel) 1 in the MPP. “Operating the PV panel 1 in the MPP” means that power converter 2 controlled by the controller 5 draws an input current I1 from the PV panel 1 such that PV panel 1 is operated in the MPP. According to one embodiment, the controller 5 based on the input voltage signal S_{V1} and the input current signal S_{I1} calculates the instantaneous level of the output power of the PV panel 1 and adjusts the input current I1 drawn from the PV panel by the activated one of the first and second converters 3, 4 such that at a given solar power received by the PV panel 1, the PV panel 1 provides a maximum output power.

One of a plurality of commonly known algorithms may be used in the controller 5 to find the MPP and to adjust the input current I1. Examples of those algorithms include the “Hill Climbing Algorithm” and the “Perturb and Observe Algorithm”. According to one embodiment the controller 5 is configured, by controlling the activated one of the first and second converters 3, 4, to vary the level of the input current I1 within a given input current range, to measure the output power of the PV panel 1 for each of these input current levels, and to adjust the input current I1 to that level for which the maximum output power has been detected. According to one embodiment, the controller 5 is configured to periodically check, by varying the level of the input current I1, if the instantaneous operation point of the PV panel 1 is still the MPP or whether the MPP has changed. If the MPP has changed, the controller 5 is configured to re-adjust the level of input current I1 such that the PV panel 1 again operates in the MPP. The controller 35 may be implemented using dedicated circuitry or may be implemented using hardware such as, for example, a microcontroller and software running on the hardware.

Providing the input current signal S_{I1} and the input voltage signal S_{V1} to the controller 5 in order to enable the controller 5 to operate the PV panel 1 in the MPP is only an example. According to a further embodiment, the controller 5 receives signals representing the output voltage V3 and the output current I20 of the power converter 2 and adjusts the input current I1 such that the output power of the power converter 2 reaches a maximum, wherein the output power is defined by the product of the output current I20 and the output voltage V3. The output current I20 of the power converter 2 equals the output current I20 of the power converter circuit which is defined by the load. However, any other algorithm for detecting the MPP of a PV panel, such as PV panel 1 shown in FIG. 4, and for adjusting the input current I1 such that the PV panel 1 is operated in the MPP could be used as well.

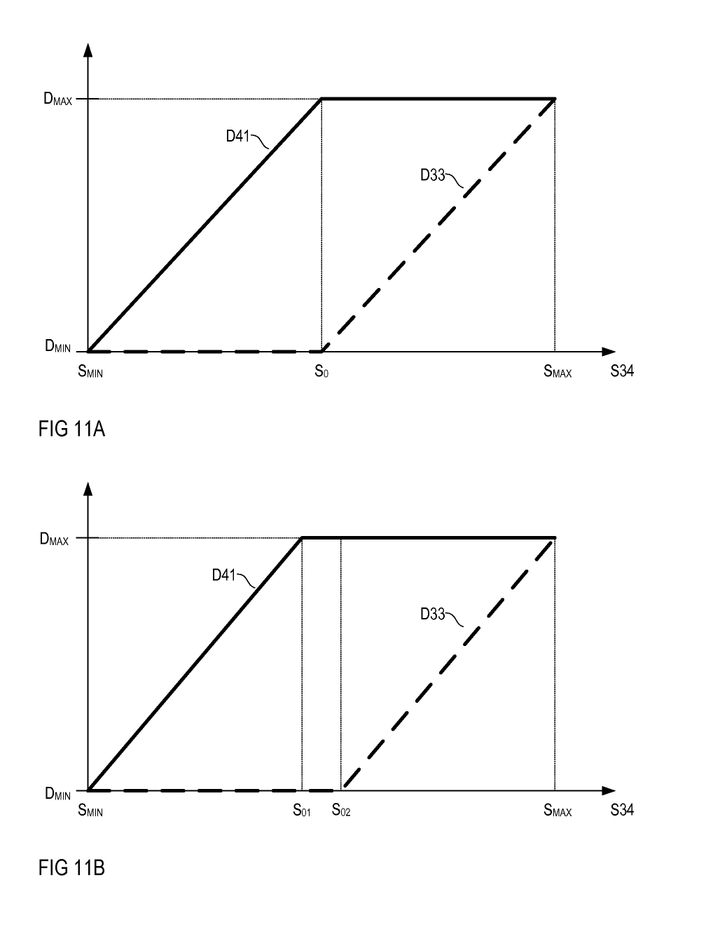

Referring to the explanation above, at a given output current I20 defined by the load Z, the output voltage V2 of the power converter may vary dependent on the input power received from the PV panel 1. According to one embodiment, the controller, at one time, is configured to activate one of the first and second converters 3, 4 and to deactivate the other one of the first and second converters 3, 4. based on comparing the instantaneous input voltage V1 with the instantaneous output voltage V2. Embodiments of an algorithm implemented in the controller 5 for activating one of the first and second controller 3, 4 and deactivating the other one of the first and second controller 3, 4 are explained with reference to FIGS. 11A and 11B below.

FIG. 5 illustrates one embodiment of a first converter 3 of one power converter 2. The first converter 3 shown in FIG. 5 is implemented as a boost converter. It includes an input which corresponds to the input 21, 22 of the power converter 2. A series circuit with a first inductor 31 such as, for example, a choke and a first switch 33 is connected in series between the input nodes 21, 22. A series circuit with a first rectifier element 32 and an output capacitor 34 is connected in parallel with the first switch 33, wherein the output voltage V3 of the first converter 3 is available across the output capacitor 34. The first rectifier element 32 is drawn as a diode in the embodiment shown in FIG. 5. However, implementing the first rectifier element 32 as a diode is only an example. Other types of rectifier elements may be used as well to implement the first rectifier element 32. One example of another type of rectifier element is a synchronous rectifier (SR) which includes a MOSFET (Metal Oxide Semiconductor Field-Effect Transistor).

The first switch 33 can be implemented as a conventional electronic switch such as, for example, a MOSFET, an IGBT (Insulated Gate Bipolar Transistor), a BJT (Bipolar Junction Transistor), a HEMT (High Electron-Mobility Transistor), or the like. A drive circuit 35 drives the first switch 33 based on the first control signal S3 received from the controller 5 (see FIG. 4, not shown in FIG. 5). In particular, the drive circuit 35 drives the first switch 33 in a pulse-width modulated (PWM) fashion using a drive signal S33, wherein the drive signal S33 has a duty cycle which is defined by the first control signal S3.

The first converter 3 shown in FIG. 5 can be operated in an activated state or in a deactivated state. In the activated state, the first switch 33 of the first converter 3 is switched on and off in a PWM fashion based on the—drive signal S33 received from the drive circuit 35. In this operation mode, the first converter 3 adjusts the input current I1 in a way that is explained in further detail herein below. In the deactivated state, the drive signal S33, according to one embodiment, permanently switches off the first switch, so that the current I1 received from the power source 1 and defined by the second converter 4 (not shown in FIG. 5) permanently flows through the inductor 31 and the rectifier element 32, respectively. According to another embodiment, in the deactivated state, the drive signal S33 operates the first converter 3 at a minimum duty cycle. This is explained in further detail below.

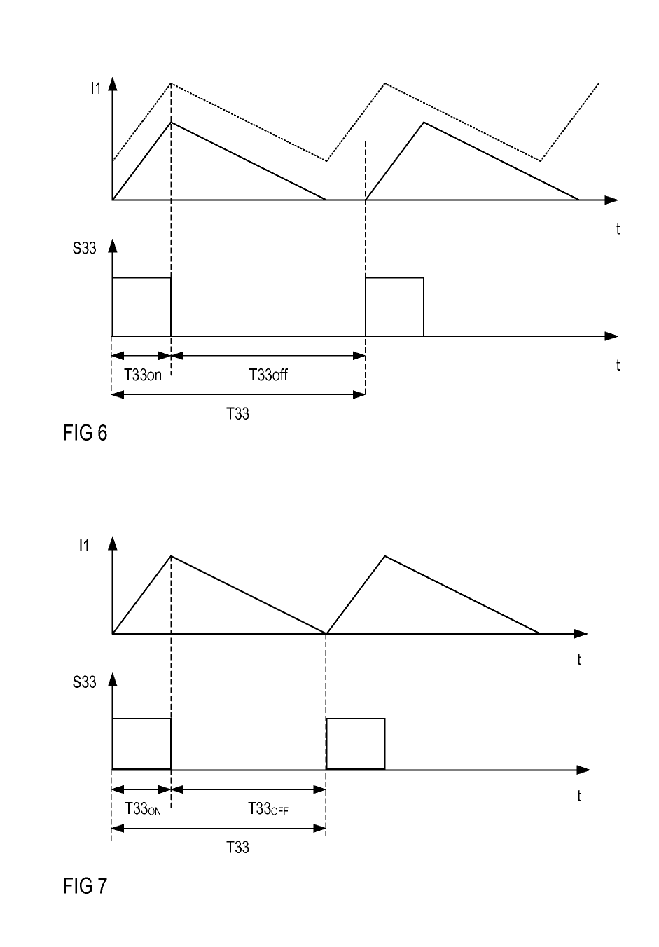

Three embodiments of how the drive circuit 35 may operate the switch 33 in the activated state are explained with reference to FIGS. 6 and 7 below. FIGS. 6 and 7 each illustrate timing diagrams of the drive signal S33 that drives the first switch 33, and of the corresponding input current I1. In each case, the drive circuit 35 operates the first switch 33 in subsequent drive cycles such that in each drive cycle the drive signal S33 switches on the first switch 33 during an on-period, and subsequently switches off the first switch 33 during an off-period. A duration of the on-period will be referred to as on-time T33ₒₙ in the following, and a duration of the off-period will be referred to as off-time T33_{off} in the following. An overall duration of one drive cycle, which corresponds to the on-time T33ₒₙ plus the off-time T33_{off}, will be referred to as cycle time T33 in the following.

A duty cycle D33 of the drive signal S33 is defined by the ratio between the duration T33ₒₙ of the on-time and the duration T33 of the cycle time, that is D33=T33ₒₙ/T33. If the duty cycle is zero (D33=0), the first switch 33 is permanently switched off. According to one embodiment, the first control signal S33 received from the controller 5 (see FIG. 5) adjusts the duty cycle of the drive signal S33.

In FIGS. 6 and 7, a high signal level of the drive signal S33 represents an on-level that switches on the first switch 33, and a low signal level represents an off-level that switches off the first switch 33. However, this is just an example and just for the purpose of illustration.

Referring to FIGS. 6 and 7, the input current I1 increases during the on-period when the first switch 33 connects the first inductor 31 between the input nodes 21, 22 so that the first inductor 31 substantially receives the input voltage V1. During the on-period, energy is magnetically stored in the first inductor 31. During the off-period, the energy stored in the first inductor 31 is transferred via the rectifier element 32 to the output of the first converter 3 and the output capacitor 34, respectively, so that the input current I1 decreases during the off-time T33_{OFF}.

Referring to the example shown in FIG. 6, the drive circuit 35 may operate the first converter 3 in a discontinuous conduction mode (DCM). In this case, the drive circuit 35 switches on the first switch 33 at a fixed frequency, so that the cycle time T33 is constant. The average input current in one drive cycle can be varied by the varying the on-time T33ₒₙ in the individual drive cycles, which is equivalent to varying the duty cycle in the individual drive cycles.

According to another embodiment shown in dotted lines in FIG. 6 the drive circuit 35 operates the first converter 3 in a continuous conduction mode (CCM). In this case, the drive circuit 35 switches on the first switch 33 at a fixed frequency, wherein the duty cycle in each drive cycle is such that the input current 11 does not decrease to zero (0) during one drive cycle.

According to another embodiment shown in FIG. 7, the drive circuit 35 operates the first converter 3 in a critical conduction mode (CrCM). In this operation mode, the drive circuit 35 detects the magnetization of the first inductor 31 and switches on the first switch 33 each time the first inductor 31 has been demagnetized, that is, each time the input current I1 has decreased to zero during the off-period. In this embodiment, the average input current I1 can be varied by varying the on-time T33ₒₙ.

In each of the three operation modes explained above, the average input current I1 is dependent on the on-time T33_{ON} or the duty cycle D33, respectively. The “average input current” is the average of the input current over one drive cycle. Thus, the controller 5, by adjusting the duty cycle D33 using the first control signal S3, can adjust the (average) input current I1 in order to operate the PV panel 1 in the MPP.

If the power source 1 provides a certain input power to the first converter 3, increasing the level of the average input current I1 results in a decreasing level of the input voltage V1, and decreasing the level of the average input current I1 results in an increasing level of input voltage V1. Referring to the explanation above, the controller 5 may vary the (average) input current I1 in order to operate the PV panel in the MPP.

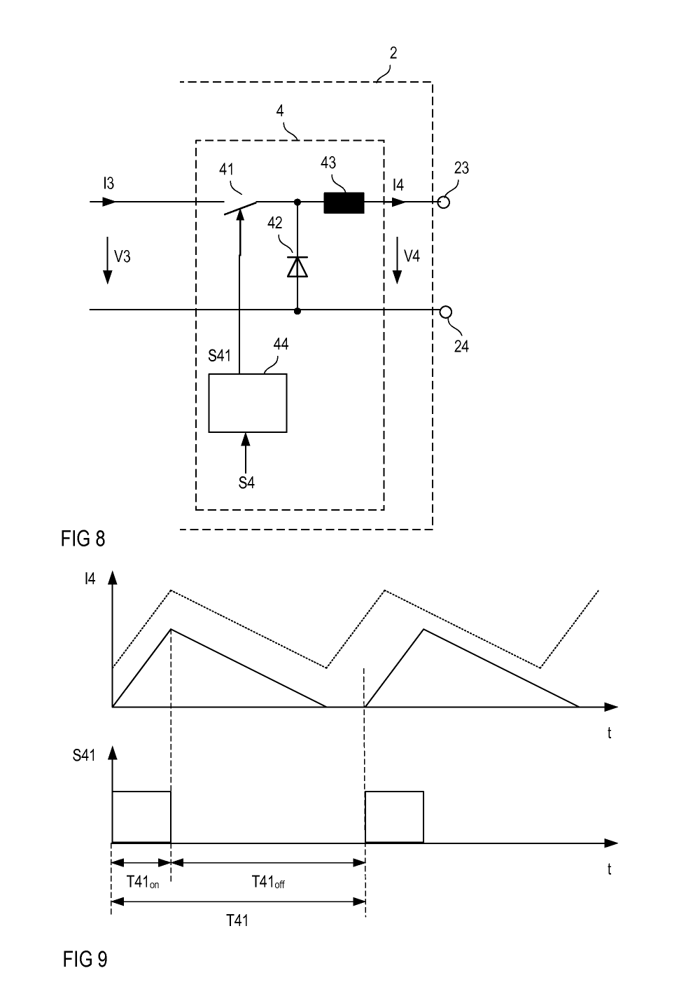

FIG. 8 illustrates one embodiment of the second converter 4 that receives the output current I3 and the output voltage V3 from the corresponding first converter 3. The second converter shown in FIG. 8 is implemented as a buck converter which includes a series circuit with a second switch 41 and a second inductor 43 connected between one output node of the first converter 3 and one output node 23 (the first output node 23 in the present embodiment) of the second converter 4. A second rectifier element 42 is connected between the other output node 24 and a circuit node between the second switch 41 and the second inductor 43.

The second rectifier element 42 is drawn as a diode in the embodiment shown in FIG. 7. However, implementing the second rectifier element 42 as a diode is only an example. Other types of rectifier elements may be used as well to implement the first rectifier element 42. One example of another type of rectifier element is a synchronous rectifier (SR) which includes a MOSFET (Metal Oxide Semiconductor Field-Effect Transistor). The second switch 41 can be implemented as a conventional electronic switch such as, for example, a MOSFET, an IGBT (Insulated Gate Bipolar Transistor), a BJT (Bipolar Junction Transistor), a HEMT (High Electron-Mobility Transistor), or the like. The inductor 43 may include a choke and may additionally include line inductances resulting from connection lines between the outputs of the individual power converters 2₁-2ₙ (see FIG. 1) and between the outputs of the power converters 2₁-2ₙ and the output of the power converter circuit 20, respectively.

A drive circuit 44 drives the first switch 41 based on the second control signal S4 received from the controller 5 (see FIG. 4, not shown in FIG. 8). In particular, the drive circuit 44 drives the second switch 41 in a pulse-width modulated (PWM) fashion using a drive signal S41, wherein the drive signal S41 has a duty cycle which is defined by the second control signal S4.

Like the first converter 3, the second converter 4 shown in FIG. 8 can be operated in an activated state or in a deactivated state. In the activated state, the second switch 41 of the second converter 4 is switched on and off in a PWM fashion based on the drive signal S41 received from the drive circuit 41. In this operation mode, the second converter 4 adjusts the input current I1 in a way that is explained in further detail herein below. In the deactivated state, according to one embodiment, the drive signal S41 permanently switches on the first switch, so that the current I1 received from the power source 1 and defined by the first converter 3 (not shown in FIG. 5) permanently flows through the switch 41 and the inductor 43, respectively. According to another embodiment, in the deactivated state, the drive signal S41 operates the second converter at a maximum duty cycle. This is explained in further detail below.

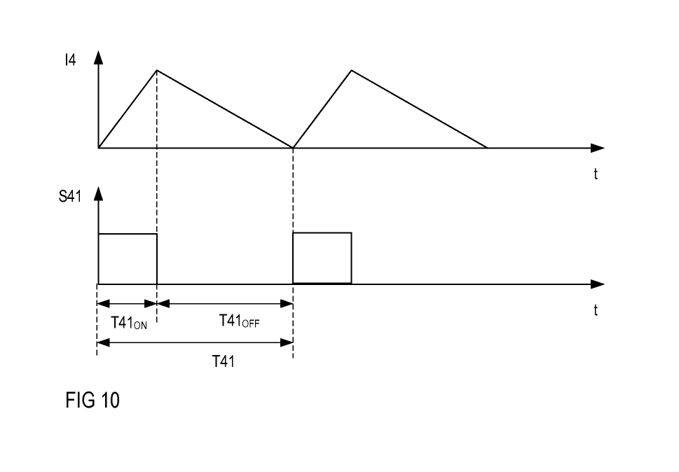

Three embodiments of how the drive circuit 44 may operate the second switch 41 are explained with reference to FIGS. 9 and 10 below. FIGS. 9 and 10 each illustrate timing diagrams of the drive signal S41 that drives the second switch 41, and of the corresponding output current I4. In each case, the drive circuit 44 operates the second switch 41 in subsequent drive cycles such that in each drive cycle the drive signal S41 switches on the second switch 41 in an on-period, and subsequently switches off the second switch 41 in an off-period. A duration of the on-period will be referred to as on-time T41ₒₙ in the following, and a duration of the off-period will be referred to as off-time T41_{off} in the following. An overall duration of one drive cycle, which corresponds to the on-time T41ₒₙ plus the off-time T41_{off}, will be referred to as cycle time T41 in the following.

A duty cycle D41 of the drive signal S41 is defined by the ratio between the duration T41 ₒₙ of the on-time and the duration T41 of the cycle time, that is D41=T41ₒₙ/T41. If the duty cycle is one (D41=1), the second switch 41 is permanently switched on.

In FIGS. 9 and 10, a high signal level of the drive signal S41 represents an on-level that switches on the first switch 41, and a low signal level represents an off-level that switches off the first switch 41. However, this is just an example and just for the purpose of illustration.

Referring to FIGS. 9 and 10, the output current I4 increases during the on-period when the second switch 41 connects the second inductor 43 between the output of the first converter 3 (not shown in FIG. 8) where the output voltage V3 and the output current I3 are available and the output of the second converter 4, so that the second inductor 43 receives a voltage which substantially corresponds to the output voltage V3 of the first converter 3 minus the out-put voltage of the second converter 4. During the on-period, energy is magnetically stored in the second inductor 43. During the off-period, the energy stored in the second inductor 43 is transferred to the output 23, 24 of the second converter 4 so that the output current I4 decreases during the off-time T41_{off}. During the off-period, the second rectifier element 42 acts as a freewheeling element which allows the output current I4 to continue to flow through the inductor 43 after the second switch has been switched off.

Referring to the example shown in FIG. 9, the drive circuit 44 may operate the second converter 4 in a discontinuous conduction mode (DCM). In this case, the drive circuit 44 switches on the second switch 41 with a fixed frequency, so that the cycle time T41 is constant. The average output current in one drive cycle can be varied by varying the on-time T41ₒₙ in the individual drive cycles, which is equivalent to varying the duty cycle in the individual drive cycles. The duty cycle is the ratio between the on-time T41ₒₙ and the cycle time T41ₒₙ (T41ₒₙ/T41).

According to another embodiment shown in dotted lines in FIG. 9 the drive circuit 44 operates the second 4 in a continuous conduction mode (CCM). In this case, the drive circuit 44 switches on the second switch 41 at a fixed frequency, wherein the duty cycle in each drive cycle is such that the output current 14 does not decrease to 0 during one duty cycle.

According to yet another embodiment, shown in FIG. 10, the drive circuit 44 operates the second converter 4 in a critical conduction mode (CrCM). In this operation mode, the drive circuit 44 detects the magnetization of the second inductor 43 and switches on the second switch 41 each time the second inductor 43 has been demagnetized, that is, each time the input current I3 has decreased to zero during the off-period. In this embodiment, the average input current I3 can be varied by varying the on-time T41ₒₙ.

In each of the three operation modes explained above, the average input current I3, which corresponds to the input current I1 received from the PV panel when the first converter 3 (not shown in FIG. 8) is deactivated and the second converter 4 is activated, is dependent on the on-time T41_{ON} or the duty cycle D41, respectively. The “average input current” is the average of the input current over one drive cycle. Thus, the controller 5, by adjusting the duty cycle D41 using the second control signal S4, can adjust the (average) input current I1 in order to operate the PV panel 1 in the MPP.

A switching frequency of the drive circuits 35, 44 in the first and second converters 3, 4 is for example between several 10 kHz and several 100 kHz, or even more. The “switching frequency” is the frequency at which the drive circuit 35, 44 switches on the corresponding switch 33, 41 in the activated state of the respective first or second converter 3, 4.

According to one embodiment, the controller 5 is configured to generate only one control signal that is received by the first and second converters 3, 4. In this case, the first control signal S3 and the second control signal S4 shown in FIG. 4 are equal, that is, S3=S4. One way of operation of a power converter 2 implemented with a controller 5 which generates only one control signal (S3=S4) is explained with reference to FIG. 11A below. In the following, S34 (=S3=S4) denotes the one control signal generated by the controller 5 and received by both the first converter 3 and the second converter 4.

FIG. 11A schematically illustrates the control signal S3=S4 provided by the controller 5 and the duty cycles D33, D41 of the first drive signal S33 (see FIG. 5) the first drive circuit 35 (see FIG. 5) generates based on the control signal S34, and the second drive signal S41 (see FIG. 8) the second drive circuit 44 generates based on the control signal S34.

Referring to FIG. 11A, the controller 5 may generate the control signal S34 such that a signal level of the control signal ranges between a minimum level S_{MIN} and a maximum level. Each signal level of the control signal S34 is associated with a duty cycle D33 of the drive signal S33 in the first converter 33, and a duty cycle D41 of the drive signal S41 in the second converter 41. Each of these duty cycles D33, D41 may range between a minimum level D_{MIN} and a maximum level D_{MAX}.

In embodiment shown in FIG. 11A, the duty cycle D33 of the first converter 33 substantially has the minimum level D_{MIN} when the signal level of the control signal S34 is between the minimum signal level S_{MIN} and a threshold level S₀, while the duty cycle D41 of the second converter 4 increases as the signal level of the control signal S34 increases between the minimum signal level S_{MIN} and the threshold level S₀. In the following, the range between the minimum signal level S_{MIN} and the threshold level S₀ will be referred to as first interval. As outlined above, there is an operation mode in which the first converter 3 is deactivated. According to one embodiment, the first converter is deactivated when the corresponding duty cycle D33 has the minimum level D_{MIN}, and the second converter 4 is activated when the duty cycle D41 is below the maximum level D_{MAX}. Thus, the first converter 3 is deactivated and the second converter 4 is activated when the signal level of the control signal S34 is in the first interval.

Further, the duty cycle D41 of the second converter 41 substantially has the maximum level D_{MAX} when the signal level of the control signal S34 is between the threshold level S₀ and the maximum level S_{MAX}, while the duty cycle D33 of the first converter 3 increases as the signal level of the control signal S34 increases between the threshold level S₀ and the maximum signal level S_{MAX}. In the following, the range between the threshold level S₀ and the maximum signal level S_{MAX} will be referred to as second interval. As outlined above, the second converter 41 is deactivated when the corresponding duty cycle D41 has the maximum level D_{MAX}, and the first converter 3 is activated when the duty cycle D33 has the minimum level. Thus, the second converter 4 is deactivated and the first converter 2 is activated when the signal level of the control signal S34 is in the second interval.

FIG. 11A shows the duty cycles D41, D33 to continuously increase as the signal level of the control signal S34 increases in the first and second intervals, respectively, wherein each signal level of the control signal S34 is associated with a different duty cycle level of the duty cycles D33, D41. However, this is only for the purpose of explanation. The control signal S34 can be an analog signal (as schematically shown in FIG. 11A). According to another embodiment, the control signal S34 is a digital (discrete) signal that can assume only a predefined number of different signal level, wherein each of these signal levels has a duty cycle level of the first duty cycle D33 and a duty cycle level of the second duty cycle D41 associated therewith.

The first and second drive circuits 35, 44 are configured to generate the first and second drive signals S33, S41 with a duty cycle which is based on the control signal S34 in accordance with the characteristic curve shown in FIG. 11A. According to one embodiment, each of the first and second drive circuits 35. 44 includes a look-up table which maps signal levels of the control signal S34 to corresponding duty cycle levels in accordance with characteristic curve shown in FIG. 11. That is, the first drive circuit 33 includes a first look-up table which maps signal levels of the control signal S34 to duty cycle levels in accordance with the curve labeled with “D33” in FIG. 11, and the second drive circuit 45 includes a second look-up table which maps signal levels of the control signal S34 to duty cycle levels in accordance with the curve labeled with “D41” in FIG. 11. According to another embodiment, each of the first and second drive circuits 35, 44 includes a calculation unit which calculates the duty cycle level based on the signal level of the control signal. The calculation unit in the first drive circuit 35 may calculate the duty cycle level of the duty cycle D33 as follows,

D33=D_{MIN} if S34≦S₀

D33=(S34−S₀)/(S_{MAX}−S₀) if S34>S₀ (1)

while the calculation unit in the second drive circuit 35 may calculate the duty cycle level of the duty cycle D41 as follows,

D41=(S34−S_{MIN})/(S₀−S_{MIN}) if S34≦S₀

D41=D_{MAX} if S34>S₀ (2).

Each of the first and second drive circuits 35, 44 may further include a PWM modulator which receives the looked-up or calculated duty cycle level and generates the corresponding drive signal in accordance with this duty cycle level. Such PWM modulators are known so that no further explanations are required in this regard.

In order to prevent the power converter 2 from frequently switching between the first converter 3 and the second converter 4 when the control signal S34 is near S₀, the power converter 2 may be operated in accordance with the characteristic curve shown in FIG. 11B. In this embodiment, there are two different thresholds S₀₁, S₀₂, wherein the first duty cycle D33 has the maximum level and the second duty cycle has the minimum level if the control signal S34 is between these two thresholds. Based on equations (1) and (2), the characteristic curve shown in FIG. 11B, that is, the first duty cycle D33 and the second duty cycle D41 can be calculated as follows:

D33=D_{MIN} if S34≦S₀₂

D33=(S34−S₀₂)/(S_{MAX}−S₀₂) if S34>S₀₂ (3)

D41=(S34−S_{MIN})/(S₀₁−S_{MIN}) if S34≦S₀₁

D41=D_{MAX} if S34>S₀₁ (4).

One way of operation of one power converter 2 is explained below. For the purpose of explanation it is assumed that, at first, the controller 5 keeps the signal level of the control signal S34 at the minimum level S_{MIN}. Thus, the first converter 3 is deactivated (D33=D_{MIN}) and the duty cycle D41 of the second converter D4 has the minimum level D_{MIN}, so that the second switch 41 (see FIG. 8) substantially prevents a current from flowing from the power source 1 to the load Z. The controller then starts to increase the signal level of the control signal S34, thereby causing the second converter 4 to draw a current from the power source 1, while the first converter 3 is deactivated (that is, it allows the current drawn by the second converter 4 to pass). As the controller 5 increases the signal level of the control signal S34 it monitors the power provided by the power source 1 in the way explained before. An increasing signal level of the control signal S34 results in an increasing duty cycle of, first, the second converter 4 and, then, the first converter 3, so that the input current I1 increases as the signal level of the control signal S34 increases.

The controller 5 stops to increase the signal level of the control signal S34, or even reduces the signal level, when it detects that a further increase of the signal level results in a decreasing power provided by the power source, that is, when the MPP of the power source 1 has been reached. The controller 5 may keep the signal level of the control signal S34 where the MPP of the power source 1 was detected and, from time to time, may slightly vary the input current I1 by varying the signal level S34 of the control signal in order to detect whether the power source 1 still operates in the MPP.

The individual power converters 2₁-2ₙ of the power converter circuit 20 may operate autonomously. That is, each of the power converters 2₁-2ₙ only adjusts the input current I1₁-I1ₙ such that the corresponding power source 1₁-1ₙ is operated in the MPP. A communication between the individual power converters 2₁-2ₙ is not required.

Referring to the explanation above, the first converter 3 is deactivated when the duty cycle D33 of the first converter 3 has the minimum level D_{MIN}, and the second converter 4 is deactivated when the second switch 41 has the maximum level D_{MAX}. According to one embodiment, D_{MIN}=0. In this case, the first switch 33 in the first converter is permanently switched off when the first converter 3 is deactivated. According to one embodiment, D_{MAX}=1 (D_{MAX}=100%). In this case, the second switch 41 in the second converter 4 is permanently switched on when the second converter 4 is deactivated.

However, there may be reasons not to permanently switch off the first switch 33 and/or not to permanently switch on the second switch 41. For example, in the second converter 4 shown in FIG. 8 a supply voltage of the drive circuit 44 may be generated using a bootstrap circuit (not shown) from a voltage across the second switch 41. This, however requires the second switch 41 to be operated in a switched-mode. Thus, according to one embodiment, D_{MAX} is lower than 100%. Thus, in the deactivated state of the second converter 4, the second switch 41 is not permanently switched on but is operated at a high duty cycle other than 100%. For example, D_{MAX} is between 97% and 99.9%. When operated at the maximum duty cycle D_{MAX}, the second converter 4 substantially passes the current provided by the first converter 3 so that the second converter 4 can be considered to be deactivated when operated at D_{MAX}.

Equivalently, the first converter 3 may be operated such that in the deactivated state the first switch 33 is not permanently switched off. That is the first converter is operated at a minimum duty cycle D_{MIN} other than zero (0%). For example, D_{MIN} is between 0.1% and 3%. When operated at the minimum duty cycle D_{MIN}, the first converter 3 substantially passes the current drawn by the second converter 4 so that the first converter 3 can be considered to be deactivated when operated at D_{MIN}.

According to one embodiment, in the deactivated state of the first converter 3 is operated in a burst mode. In the burst mode, the first switch 33 is not operated (switched on) in each drive cycle, so that there are drive cycles where the duty cycle D33 is zero. These drive cycles will be referred to as a sleep cycles in the following. Further, there are drive cycles in which the first switch 33 is operated at a predefined burst mode duty cycle other than zero. For example, the burst mode duty cycle is selected from a range of between 1% and 5%. These drive cycles will be referred to as burst cycles in the following. Sleep cycles and burst cycles can be combined widely arbitrarily. According to one embodiment, every sequence with a predefined first number N1 (with N1≧1) of sleep cycles is followed by a predefined second number N2 (with N2≧1) of burst cycles.

Equivalently, the second converter 4, in the deactivated state, can be operated in a burst mode. The burst mode of the second converter 4 is different from the burst mode of the first converter 3 in that in the sleep cycles of the second converter 4 the duty cycle D41 is 100%, so that the second switch 41 is permanently switched on. In the burst cycles, the second switch 41 is operated at a predefined burst mode duty cycle other than 100%. For example, the burst mode duty cycle is selected from a range of between 95% and 99%.

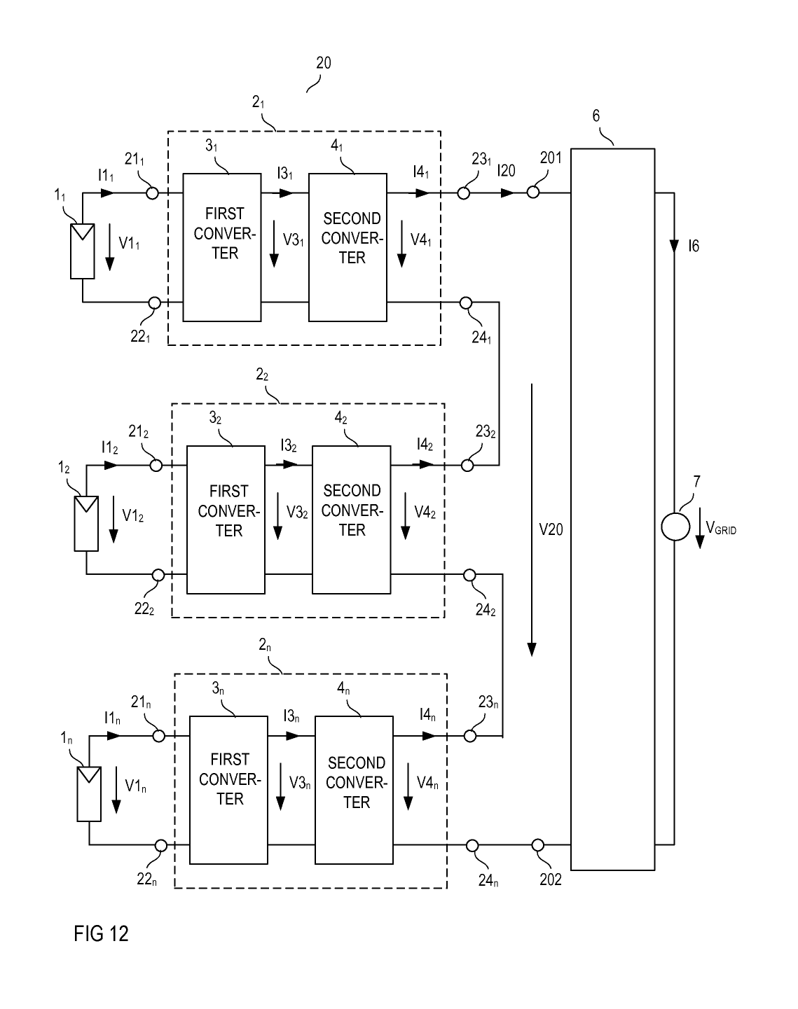

FIG. 12 shows a further embodiment of a power converter circuit. In this embodiment, a further power converter 6 receives the output voltage V20 and the output current I20 from the power converter circuit 20 explained above. In the following, the power converter circuit 20 will be referred to as first power converter circuit, and the further power converter 6 will be referred to as second power converter circuit in the following. According to one embodiment, the second power converter circuit 6 is a power inverter which is configured to receive the direct current (DC) I20 from the first power converter circuit 20 and to supply an alternating current (AC) 16 to a power grid. The power grid is represented by an alternating power source 7 in the embodiment shown in FIG. 12. A power inverter configured to convert a direct input current into an alternating output current is known, so that no further explanation is required in this regard.

According to one embodiment, the second power converter circuit 6 is further configured to control the input current I20 received from the first power converter circuit 20 such that the power received from the first power converter circuit 20 reaches a maximum. That is, the second power converter circuit 6 may additionally operate like a MPP tracker which is configured to vary the input current 120 and to measure the input power received from the first power converter circuit 20 in order to maximize the input power received from the first power converter circuit 20.

According to another embodiment, the second power converter 6 is configured to adjust the input current I20 such that the input voltage V20 is substantially constant. The input current I20 multiplied by the input voltage V20 equals the input power of the second power converter circuit 6. This input power substantially corresponds to the power supplied by the cascaded power converters 2₁-2ₙ. This power may vary dependent on the solar power received by the individual PV panels 1₁-1ₙ. At a given input current I20 the input voltage V20 increases as the power provided to second power converter circuit 6 increases, and the input voltage V20 decreases as the power provided to second power converter circuit 6 decreases. Thus, the second power converter circuit 6 is configured to decrease the input current I20 when the input voltage V20 decreases so as to counteract the decrease of the input voltage V20 and to keep the input voltage V20 substantially constant, and to increase the input current I20 when the input voltage V20 increases so as to counteract the increase of the input voltage V20 and to keep the input voltage V20 substantially constant.

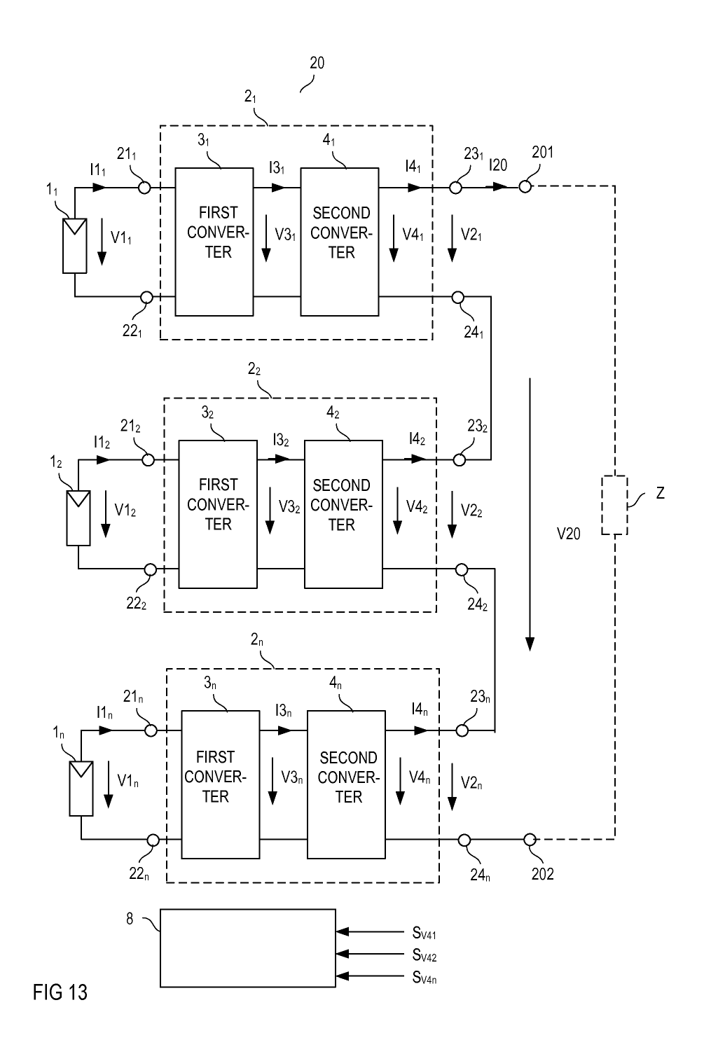

According to another embodiment shown in FIG. 13, there is a master controller 8 which, in the embodiment where the second power converter circuit 20 controls the output voltage V20, receives signals representing the instantaneous output powers of the individual second converters 4₁-4ₙ. These signals S_{V41}-S_{V4n} may, for example, represent the individual output voltages V4₁-V4ₙ, as these output voltages V4₁-V4ₙ represent the output powers of the individual converters 4₁-4ₙ when the output currents I4₁-I4ₙ of the individual second converters are substantially equal. According to one embodiment, the master controller 7 is configured to detect those of the power converters 2₁-2ₙ that have an instantaneous output power lower than predefined power level, and to switch off those power converters. Switching off a power converter 2 with an instantaneous output power lower than the predefined power level includes operating the power converter 2 in an operation mode in which it allows the output current I20 to pass. This may include switching off the second switch 41 (see FIG. 8) in the respective second converter 4 as long as the power converter 2 is to be deactivated. In the deactivated state, the rectifier element 42 (see FIG. 8) of the second converter allows the current provided by activated second converters to flow through the second converter 4.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

Spatially relative terms such as “under,” “below,” “lower,” “over,” “upper” and the like, are used for ease of description to explain the positioning of one element relative to a second element. These terms are intended to encompass different orientations of the device in addition to different orientations than those depicted in the figures. Further, terms such as “first,” “second” and the like, are also used to describe various elements, regions, sections, etc. and are also not intended to be limiting. Like terms refer to like elements throughout the description.

As used herein, the terms “having,” “containing,” “including,” “comprising” and the like are open ended terms that indicate the presence of stated elements or features, but do not preclude additional elements or features. The articles “a,” “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

1. A power converter circuit, comprising:
a plurality of power converters each comprising an input configured to receive input power from a power source, an output, a first converter connected to the input, and a second converter connected between the first converter and the output,
wherein the outputs of the plurality of power converters are connected in series at an output of the power converter circuit,
wherein the first converter includes a first inductor and wherein the second converter includes a second inductor.

2. The power converter circuit of claim 1,
wherein the first converter comprises a boost converter topology, and
wherein the second converter comprises a buck converter topology.

3. The power converter circuit of claim 2,
wherein the power source comprises a PV panel.

4. The power converter of claim 1,
wherein each of the first converter and the second is configured to be operated in one of an activated state and a deactivated state,
wherein only one of the first converter and the second converted is operated in the activated state at one time, and
wherein the one of the first converter and the second converter which is operated in the activated state is configured to control the input power received from the power source.

5. The power converter circuit of claim 4, wherein each of the power converters further comprises a controller configured to control an operation mode of each of the first converter and the second converter.

6. The power converter circuit of claim 5, wherein the controller is configured to generate one control signal received by both the first converter and the second converter.

7. The power converter circuit of claim 6,
wherein each of the first converter and the second converter is a switched-mode converter configured to operate in a switched-mode operation,
and wherein each of the first converter and the second converter is configured to adjust a duty cycle of a switched-mode operation based on the control signal.

8. The power converter circuit of claim 6, wherein the controller is configured to generate the control signal based on at least one of an input power received by the power converter, and an output power provided by the power converter.

9. The power converter circuit of claim 1, further comprising:
a further power converter connected to the output.

10. The power converter of claim 9, wherein the further power converter is configured to control the voltage at the output.

11. A method comprising:
receiving an input power from a power source by each of a plurality of power converters,
wherein each power converter comprises an input configured to receive the input power, an output, a first converter connected to the input, and a second converter connected between the first converter and the output,
wherein the outputs of the plurality of power converters are connected in series at an output of the power converter circuit,
wherein the first converter includes a first inductor and wherein the second converter includes a second inductor.

12. The method of claim 11,
wherein the first converter comprises a boost converter topology, and
wherein the second converter comprises a buck converter topology.

13. The method of claim 12,
wherein the power source comprises a PV panel.

14. The method of claim 11, comprising:
operating only one of the first converter and the second converted in the activated state at one time, and
controlling the input power received from the power source by the one of the first converter and the second converter which is operated in the activated state.

15. The method of claim 14, comprising:
in each of the power converters, controlling an operation mode of each of the first converter and the second converter by a controller.

16. The method of claim 15, comprising:
generating one control signal received by both the first converter and the second converter by the controller.

17. The method of claim 16, comprising:
operating each of the first converter and the second converter in a switched-mode operation, and
adjusting a duty cycle of the switched-mode operation in each of the first converter and the second converter based on the control signal.

18. The method of claim 16, comprising:
generating the control signal based on at least one of an input power received by the power converter, and an output power provided by the power converter.

19. The method of claim 11, further comprising:
controlling the voltage at the output by a further power converter.
